(19) United States
(12) Patent Application Publication
(10) Pub. No.: US 2012/0013628 A1
(43) Pub. Date: Jan. 19, 2012

(54) INFORMATION PROCESSING APPARATUS, SCREEN DISPLAY CONTROL METHOD AND PROGRAM

(76) Inventors: Youichi Itaki, Tokyo (JP); Michio Tomizawa, Tokyo (JP)

(21) Appl. No.: 13/138,730

(22) PCT Filed: Mar. 31, 2009
(86) PCT No.: PCT/JP2009/056639

§ 371 Date: Sep. 22, 2011

(51) Int. Cl. G09G 5/399

(52) U.S. Cl. 345/531

(57) ABSTRACT

An information processing apparatus includes memories 31 and 32; DMA controller 33 that periodically performs a data transfer from memory 31 to memory 32; display 34 that displays an image based on a video signal output from memory 31; video output terminal 35 that outputs a video signal output from memory 32 to an external device; and controller 30 that, when executing a specific application, prohibits screen information related to the specific application from being transferred by DMA controller 33, and then writes the screen information into memory 31.

### TECHNICAL FIELD

The present invention relates to an information processing apparatus such as a personal computer, and more particularly, relates to an information processing apparatus capable of outputting a video signal to an external display such as a projector.

### BACKGROUND ART

JP2005-257948A (hereinafter referred to as Patent Document 1) describes a personal computer (PC) that can output a video signal to a projector. This personal computer includes a layer capture part, a display output part, a display image generation part, a PC communication part and a control part.

The display image generation part generates a display image formed from a plurality of layers. The display output part displays a display image generated by the display image generation part. The control part retains information on a layer to be transmitted to the projector, and, based on the information, indicates to the layer capture part a layer to be transmitted.

The layer capture part captures a layer to be transmitted from among layers forming the display image generated by the display image generation part in accordance with an indication from the control part. The PC communication part transmits the layer captured by the layer capture part to the projector that is an external device. The projector displays a screen based on the layer captured at the layer capture part.

According to the personal computer, only the layer that is specified in advance is transmitted to the projector. Namely, among screens displayed on the personal computer side, information on a screen (tool screen and the like) that is not necessary to be displayed on the projector side is not transmitted to the projector.

Therefore, when an explanation of materials is made at a meeting or the like using a system in which the projector is connected to the personal computer, only screens necessary for participants can be displayed on the projection screen of the projector.

### DISCLOSURE OF THE INVENTION

However, in the personal computer of Patent Document 1, a process, in which a layer that is specified in advance (layer to be transmitted to the projector) is sorted out from an image formed from a plurality of layers, and then the sorted layer is captured, is performed through a CPU (Central Processer Unit). Thus, sorting and capture processing increase the load on the CPU.

It is an object of the present invention to provide an information processing apparatus, an image display control method and program capable of reducing the processing load on a CPU without outputting to an external display, screen information that is not necessary to be displayed on the external display.

To achieve the above object, an information processing apparatus according to an aspect of the present invention includes:

first and second memories;

a DMA controller that periodically performs a data transfer from the first memory to the second memory;

a display that displays an image based on a video signal output from the first memory;

a video output terminal that outputs a video signal output from the second memory to an external device; and

a controller that, when executing a specific application, prohibits the screen information related to the specific application from being transferred by the DMA controller, and then writes the screen information into the first memory.

An information processing apparatus according to another aspect of the present invention includes:

first and second memories;

a DMA controller that performs a data transfer from the first memory to the second memory;

a display that displays an image based on a video signal output from the first memory;

a video output terminal that outputs a video signal output from the second memory to an external device; and

a controller that writes screen information to be displayed on the display into the first memory, and periodically updates the written screen information, while at the same time controlling the DMA controller to periodically perform a data transfer, wherein

when executing a specific application, the controller writes screen information related to the specific application into the first memory, thereafter, if causing the DMA controller to perform a data transfer, deletes the screen information related to the specific application from the first memory, updates screen information other than the deleted screen information, causes the screen information that has been updated to be transferred from the first memory to the second memory, and after the transfer is completed, rewrites the screen information related to the specific application into the first memory.

A screen display control method according to an aspect of the present invention includes:

periodically performing a data transfer from a first memory to a second memory by DMA control, while at the same time displaying an image based on a video signal output from the first memory on a display, and supplying a video signal output from the second memory to a video output terminal to which an external device is connected, and

when executing a specific application, prohibiting screen information related to the specific application from being transferred by the DMA control, and then writing the screen information into the first memory.

A screen display control method according to another aspect of the present invention

which is performed at an information processing apparatus including first and second memories, a display that displays an image based on a video signal output from the first memory, and a video output terminal that outputs a video signal output from the second memory to an external device, includes:

writing screen information to be displayed on the display into the first memory, and periodically updating the written screen information, while at the same time periodically performing a data transfer from the first memory to the second memory by DMA control, and

when executing a specific application, writing screen information related to the specific application into the first memory, thereafter, if performing a data transfer by DMA control, deleting the screen information related to the specific application from the first memory, updating screen information other than the deleted screen information, causing the screen information that has been updated to be transferred from the first memory to the second memory, and after the transfer is completed, rewriting the screen information related to the specific application into the first memory.

A program according to an aspect of the present invention causes a computer to execute processes of:

periodically transferring screen information stored in a first memory to a second memory by DMA control, while at the same time displaying an image based on a video signal output from the first memory on a display, and supplying a video signal output from the second memory to a video output terminal to which an external device is connected, and

when executing a specific application, prohibiting screen information related to the specific application from being transferred by the DMA control, and then writing the screen information into the first memory.

A program according to another aspect of the present invention is a program for use in an information processing apparatus including first and second memories, a display that displays an image based on a video signal output from the first memory, and a video output terminal that outputs a video signal output from the second memory to an external device, the program causing a computer of the information processing apparatus to execute processes of:

writing screen information to be displayed on the display into the first memory, and periodically updating the written screen information, while at the same time periodically performing a data transfer from the first memory to the second memory by DMA control, and

when executing a specific application, writing the screen information related to the specific application into the first memory, thereafter, if a data transfer is performed by the DMA control, deleting the screen information related to the specific application from the first memory, updating screen information other than the deleted screen information, causing the screen information that has been updated to be transferred from the first memory to the second memory, and after the transfer is completed, rewriting the screen information related to the specific application into the first memory.

### BRIEF DESCRIPTION OF THE DRAWINGS

FIG. 1 is a block diagram showing a configuration of the main parts of an information processing apparatus according to a first exemplary embodiment of the present invention;

FIG. 2 is a flowchart showing the procedure of screen display control processing executed at the information processing apparatus shown in FIG. 1;

FIG. 3 is a schematic diagram showing a system in which a projector is connected to the information processing apparatus shown in FIG. 1;

FIG. 4 is a schematic diagram showing an example of a GUI screen of a remote control tool of the projector;

FIG. 5 is a block diagram showing a configuration of an information processing apparatus according to a second exemplary embodiment of the present invention; and

FIG. 6 is a schematic diagram showing by way of a screen image the changes in screen information stored in each memory in an information processing apparatus according to another exemplary embodiment of the present invention.

### DESCRIPTION OF SYMBOLS

30 CONTROLLER
31, 32 MEMORY
33 DMA CONTROLLER
34 DISPLAY
35 VIDEO OUTPUT TERMINAL

### BEST MODE FOR CARRYING OUT THE INVENTION

Next, exemplary embodiments of the present invention will be described with reference to the drawings.

### First Exemplary Embodiment

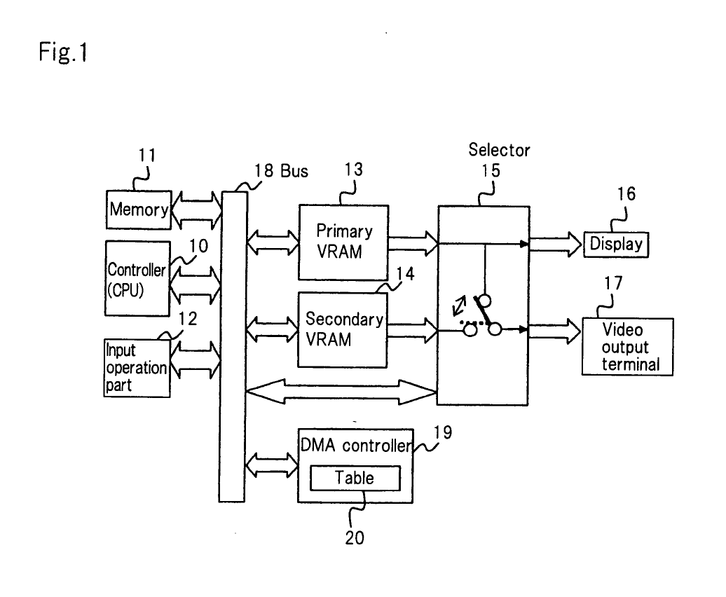

FIG. 1 is a block diagram showing a configuration of the main parts of an information processing apparatus according to a first exemplary embodiment of the present invention.

Referring to FIG. 1, the information processing apparatus is a computer device typified by a personal computer, and includes, as main parts, controller 10, memory 11, input operation part 12, primary VRAM (Video Random Access Memory) 13, secondary VRAM 14, selector 15, display 16, video output terminal 17 and DMA (Direct Memory Access) controller 19.

Controller 10, memory 11, input operation part 12, primary VRAM 13, secondary VRAM 14, selector 15 and DMA controller 19 are each connected to bus 18. Display 16 is comprised of a display device such as a liquid crystal display. Video output terminal 17 outputs a video signal to an external display such as a projector. An address in a memory space of primary VRAM 13 corresponds in a one-to-one fashion to an address in a memory space of secondary VRAM 14.

Programs necessary to operate the information processing apparatus, various applications and data are stored in memory 11. An application related to a GUI and display screen information therefor are also stored in memory 11. The application related to a GUI includes a specific application (tool) to remotely control a projector.

Selector 15 includes first and second input ports, and first and second output ports. The output signal from primary VRAM 13 is supplied to the first input port of selector 15. The output signal from secondary VRAM 14 is supplied to the second input port of selector 15.

DMA controller 19 controls a data transfer from primary VRAM 13 to secondary VRAM 14. Specifically, DMA controller 19 includes table 20 in which address information indicating a data range for primary VRAM 13 to perform a transfer is stored, and refers to table 20 to copy (draw) screen information from primary VRAM 13 to secondary VRAM 14. The drawing by DMA controller 19 is performed at regular intervals. In table 20, address information specifying the entire address space of primary VRAM 13 as a data range to which a transfer is to be performed is stored as the default value.

In addition, when address information indicating a copy-prohibited range is stored in table 20, DMA controller 19 performs no data transfer from primary VRAM 13 to secondary VRAM 14 for the copy-prohibited range. Namely, DMA controller 19 transfers screen information that is not included in the copy-prohibited range from primary VRAM 13 to secondary VRAM 14.

In selector 15, in accordance with a switching signal from controller 10, switching is performed between a first state in which the first input port is connected to the first and second output ports and a second state in which the first input port is connected to the first output port and the second input port is connected to the second output port.

Input operation part 12 includes a pointing device typified by a mouse and the like, and a keyboard. A user uses input operation part 12 to perform input indication indicating that the information processing apparatus is to be operated.

Controller 10 controls the operation of the entire information processing apparatus in accordance with a program stored in memory 11. At startup of the information processing apparatus, controller 10 supplies to selector 15 a switching signal indicating that the first state is to be selected. At the same time, controller 10 acquires from memory 11 information on the bottommost layer screen of the GUI, that is, desktop screen information that is displayed at startup, and writes the acquired screen information into primary VRAM 13.

In addition, when accepting from input operation part 12 an input indication indicating that a specific application is to be executed, controller 10 executes the specific application, and supplies to the selector 15 the switching signal indicating that the second state is to be selected. At the same time, controller 10 acquires from memory 11 screen information corresponding to the specific application that has been executed, prohibits DMA controller 19 from transferring the acquired screen information, and then overwrites the screen information onto primary VRAM 13. In transfer prohibition processing, the screen information acquired from memory 11 includes address information that is to be the write destination, and controller 10 writes the address information into table 20 of DMA controller 19 as a copy-prohibited range.

Next, screen display control processing of the information processing apparatus of the present exemplary embodiment will be described.

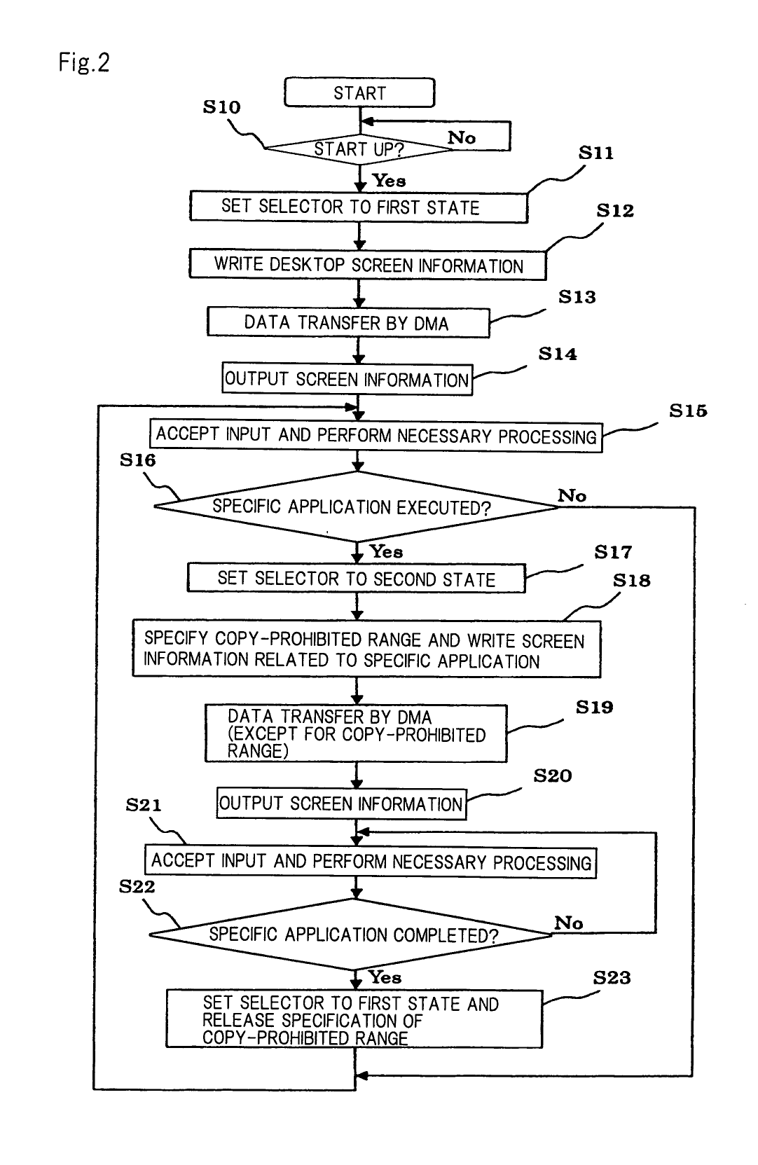

FIG. 2 is a flowchart showing the procedure of screen display control processing. Hereinafter, the operation will be described assuming that a projector is connected to video output terminal 17 as an external display.

When the information processing apparatus is activated (step S 10), controller 10 supplies to selector 15 a switching signal indicating that the first state is to be selected (step S11), while at the same time acquiring from memory 11 desktop screen information and writing the acquired screen information into primary VRAM 13 (step S12).

Next, DMA controller 19 refers to table 20 (default) to copy (draw) the screen information from primary VRAM 13 to secondary VRAM 14 (step S13). Thereafter, the output signal from primary VRAM 13 is supplied to display 16 and video output terminal 17 through selector 15 (step S14). In this case, the same screen information is displayed on both display 16 and the projector to which video output terminal 17 is connected.

After the screen information is displayed, controller 10 accepts the input from input operation part 12 and performs necessary processing (step S15).

Next, controller 10 determines whether or not an input indication, from input operation part 12, indicating that a specific application is to be executed, has been accepted (step S16). If an input indication is accepted, controller 10 executes the specific application, and supplies to selector 15 a switching signal indicating that the second state is to be selected. At the same time, controller 10 acquires from memory 11 screen information related to the specific application that has been executed, prohibits DMA controller 19 from transferring the acquired screen information, and then overwrites the acquired screen information onto primary VRAM 13 (step S18).

Next, DMA controller 19 refers to table 20 to copy (draw) screen information that is not included in the copy-prohibited range from primary VRAM 13 to secondary VRAM 14 (step S19). Thereafter, an output signal from primary VRAM 13 is supplied to display 16 through selector 15, and an output signal from secondary VRAM 14 is supplied to video output terminal 17 through selector 15 (step S20). In this case, although a screen including a GUI screen related to the specific application that has been executed is displayed on display 16, screens except for the GUI screen are displayed on the projector connected to video output terminal 17.

After the screen information is displayed, controller 10 accepts the input from input operation part 12 and performs necessary processing (step S21).

Next, controller 10 determines whether or not the input indication, from input operation part 12, indicating that the specific application is to be completed, has been accepted (step S22). If an input indication is accepted, controller 10 supplies to selector 15 a switching signal indicating that the first state is to be selected, while at the same time deleting from table 20 address information of the copy-prohibited range related to the specific application (step S23). Then, the procedure proceeds to processing of step S15.

The information processing apparatus of the present exemplary embodiment that has been described produces the following effects.

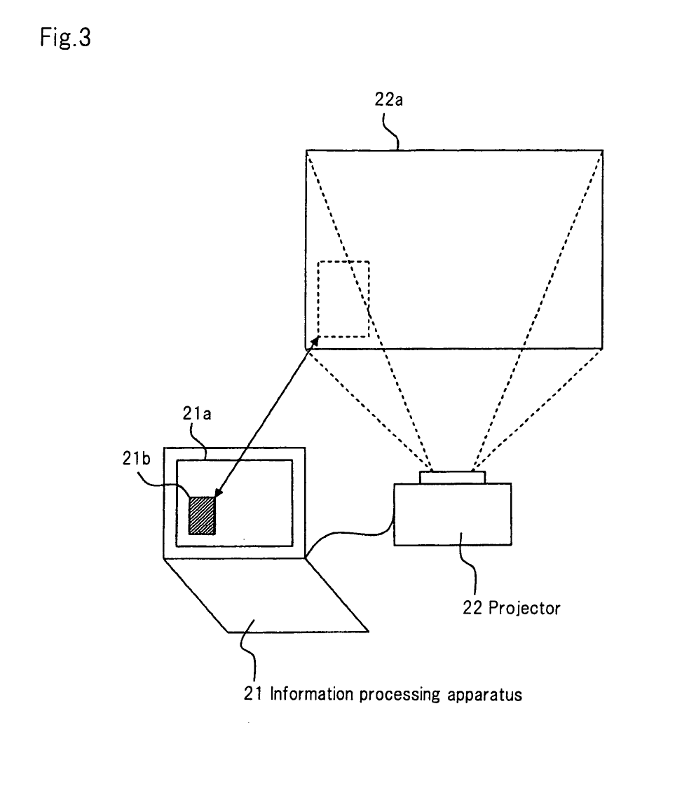

FIG. 3 schematically shows a system in which a projector is connected to an information processing apparatus of the present exemplary embodiment. In FIG. 3, information processing apparatus 21 is an information processing apparatus shown in FIG. 1. Projector 22 is connected to video output terminal 17 of information processing apparatus 21.

When processing of steps S10 to S15 shown in FIG. 2 is performed, the same screen information is displayed on screen 21a of information processing apparatus 21 and projection screen 22a of projector 22. For example, the same desktop screen information is displayed on screen 21a and projection screen 22a.

When processing of steps S16 to S21 shown in FIG. 2 is performed, screen information 21b related to the specific application is displayed on screen 21a of information processing apparatus 21, but screen information 21b is not displayed on projection screen 22a of projector 22. An image that has been displayed before the specific application is executed is displayed on the range corresponding to screen information 21b on projection screen 22a.

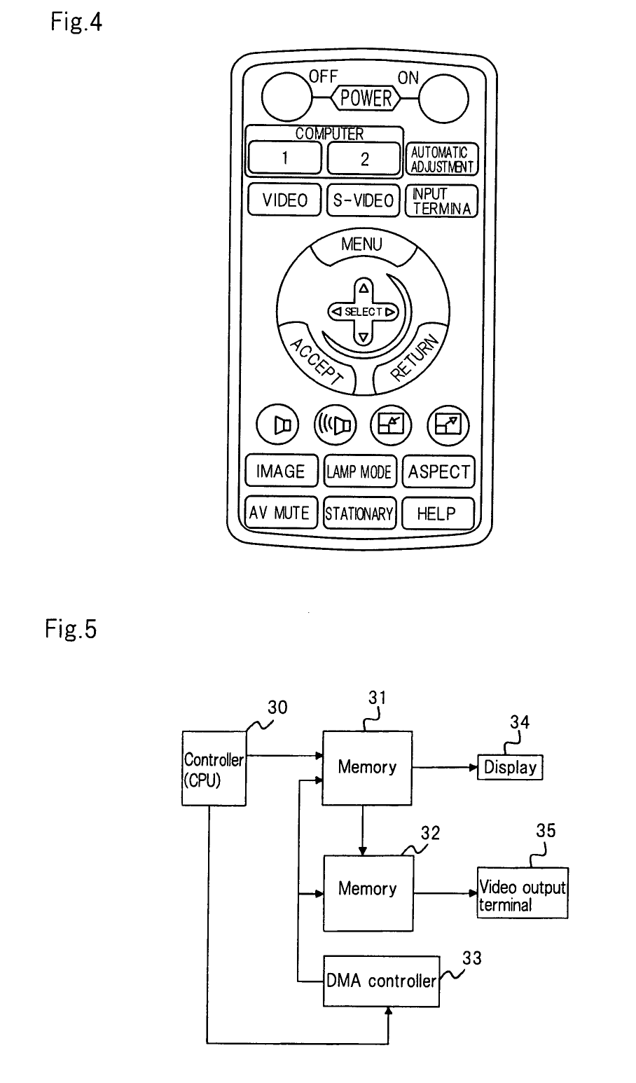

The specific application is a tool (software) to remotely control projector 22, for example. FIG. 4 shows an example of a GUI screen of a remote control tool of the projector.

A plurality of operation buttons are disposed on the GUI screen shown in FIG. 4. The user selects and inputs (clicks) an arbitrary button on the GUI screen using the mouse of input operation part 12 to operate projector 22. The GUI screen shown in FIG. 4 is displayed only on screen 21a of information processing apparatus 21 as screen information 21b.

As described above, according to the information processing apparatus of the present exemplary embodiment, when an explanation of materials is made at a meeting or the like using a system shown in FIG. 3, it is possible to prevent a screen that is not necessary for participants, for example, the GUI screen shown in FIG. 4, from being displayed on projection screen 22a of projector 22. Accordingly, it is possible to prevent the problem in which the GUI screen shown in FIG. 4 that overlaps part of the screen, on which the material displayed, on projection screen 22a and hides the overlapped part.

In addition, according to the information processing apparatus of the present exemplary embodiment, the copying (drawing) of screen information from primary VRAM 13 to secondary VRAM 14 is performed by DMA control, and controller 10 only prohibits the DMA transfer of screen information related to the specific application when the specific application is executed. Accordingly, the processing load on the CPU can be reduced by not outputting unnecessary screen information to an external display.

Basically, processing performed by controller 10 can be provided by a program. The program may be provided to a user via a storage medium such as a CD-ROM and a DVD, or through a network typified by the Internet. In addition, a program that can perform processing of steps S16 to S23 shown in FIG. 3 can be provided to the user through a storage medium and a network.

Note that in the information processing apparatus shown in FIG. 1, at startup, controller 10 determines whether or not an external display is connected to video output terminal 17, and if the external display is connected, a specific program used for remotely controlling the external display may be automatically executed.

### Second Exemplary Embodiment

FIG. 5 is a block diagram showing a configuration of an information processing apparatus according to a second exemplary embodiment of the present invention.

Referring to FIG. 5, the information processing apparatus of the present exemplary embodiment includes controller 30, memories 31 and 32, DMA controller 33, display 34 and video output terminal 35.

Screen information is stored in memories 31 and 32. Display 34 displays an image based on a video signal output from memory 31. Video output terminal 35 is a video output terminal for outputting a video signal output from memory 32 to an external device. DMA controller 33 periodically transfers screen information stored in memory 31 to memory 32. When executing a specific application, controller 30 prohibits the screen information related to the specific application from being transferred by DMA controller 33, and then writes the screen information into memory 31.

The present exemplary embodiment also produces similar effects to those of the information processing apparatus of the first exemplary embodiment.

In addition, also in the present exemplary embodiment, processing related to the screen display control by controller 30 is provided by a program. The program may be provided to a user via a storage medium such as a CD-ROM and a DVD, or through a network typified by the Internet. For example, a program is provided that causes a computer to perform a processing operation for periodically transferring screen information stored in the first memory to the second memory by DMA control, while at the same time displaying on a display an image based on a video signal output from the first memory, and supplying a video signal output from the second memory to a video output terminal to which an external device is connected, and the processing of, when executing a specific application, prohibiting the screen information related to the specific application from being transferred by the DMA control, and then writing the screen information into the first memory.

### Another Embodiment

In the information processing apparatus of the first and second exemplary embodiments, screen information (static image), which has been displayed before a specific application is executed, is displayed on the area corresponding to screen information 21b on projection screen 22a of projector 22 in a screen display form shown in FIG. 3, for example. Therefore, when the area corresponding to screen information 21b on projection screen 22a overlaps with the part of a window that displays a moving image, no screen can be updated for the overlapping portion. Here, another exemplary embodiment, in which even in such an overlapping portion, a screen can be updated, will be described.

The information processing apparatus of the other exemplary embodiment has basically the same configuration as that shown in FIG. 1 or 5; however, some operations of the controller and DMA controller are different from those of the first and second exemplary embodiments. The operation of the information processing apparatus of the other exemplary embodiment will be described below with reference to FIG. 5.

When an application for moving image is executed, controller 30 writes screen information related to the application into memory 31. In this case, since the image information is a moving image, writing of image information by controller 30 is performed on a frame basis.

When executing a specific application, controller 30 writes the screen information related to the specific application into memory 31. Then, controller 30 deletes the screen information related to the specific application written into memory 31. After the deletion, controller 30 supplies a data transfer indication signal to DMA controller 33 before the screen information for the next moving image (one frame) is written into memory 31.

DMA controller 33 starts performing a data transfer from memory 31 to memory 32 in accordance with a data transfer indication from controller 30. After the data transfer is completed, DMA controller 33 supplies to controller 30 a data transfer completion signal indicating that the data transfer has been completed.

When receiving the data transfer completion signal from DMA controller 33, controller 30 rewrites the screen information related to the specific application into memory 31.

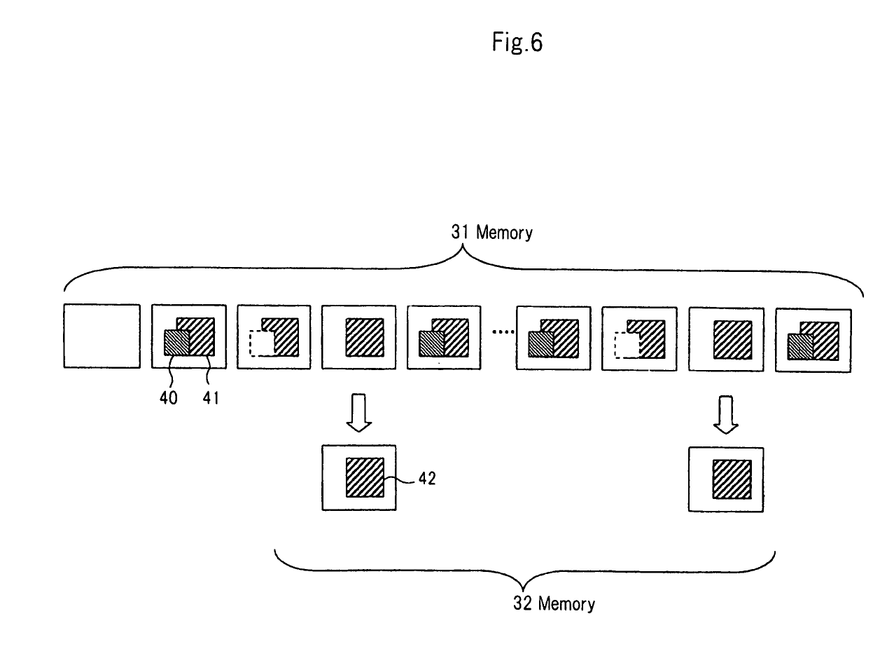

FIG. 6 schematically shows by way of a screen image the changes in screen information stored in memories 31 and 32.

In FIG. 6, the top shows the changes in the image image frame-by-frame in memory 31, and the bottom shows the changes in the image image in memory 32. Area 40 corresponds to screen information related to a specific application, and area 41 corresponds to screen information for moving image (one frame).

In the update of screen information in memory 31, update processing is performed for the overlapping portion based on a priority order referred to as Z order. Specifically, if a plurality of screens are overlapped, the ordering is such that the priority of the screen situated in the foreground is the highest, and the priority of the screen situated in the background is the lowest. The screen with a higher-priority is updated earlier, and for the screen with a lower-priority, the area of the screen other than the overlapping portion is updated. In the example shown in FIG. 6, area 40 is the most conspicuous area in the foreground, and area 41 is the most conspicuous area in the background. In this case, in area 41, screen information is not updated for the portion overlapping with area 40, and updating of screen information (frame-by-frame update) is performed for the other portions.

After writing screen information for moving image (one frame) into area 41 in memory 31, controller 30 overwrites the screen information related to the specific application into area 40 in memory 31 (see the second image from the left in FIG. 6). Thereafter, controller 30 deletes the screen information related to the specific application written into area 40 in memory 31 (see the third image from the left in FIG. 6). Thus, area 41 becomes the most conspicuous area in the foreground, and the screen information for the entire area 41 is updated.

After deleting the screen information related to the specific application, controller 30 supplies a data transfer indication signal to DMA controller 33 before the screen information for the next moving image (one frame) is written into memory 31. DMA controller 33 starts performing a data transfer from memory 31 to memory 32 in accordance with a data transfer indication from controller 30. According to this data transfer, the screen information of area 41 in memory 31, which has been updated, is transferred to area 42 in memory 32 (see the fourth image from the left in FIG. 6).

After data transfer has been completed, DMA controller 33 supplies to controller 30 a data transfer completion signal indicating that the data transfer has been completed. When receiving the data transfer completion signal from DMA controller 33, controller 30 rewrites the screen information related to the specific application into area 40 in memory 31. Thus, the sequence of screen information according to Z order is reset again in memory 31. As a result, in area 41, screen information is not updated for the portion overlapping with area 40, and updating of screen information (frame-by-frame update) is performed for the other portions.

The period required for transferring data by DMA controller 33 is longer than the period required for updating screen information of area 41 in memory 31. Since the display period of the screen information in the projector is determined according to the data transfer period, it is desirable that the data transfer period be shortened as much as possible.

The above processing may also be applied to the information processing apparatus shown in FIG. 1. In this case, the controller supplies a data transfer indication to the DMA controller, and supplies to the selector a switching signal indicating that the second state is to be selected. In addition, when receiving the data transfer completion signal from the DMA controller, the controller supplies to the selector the switching signal indicating that the first state is to be selected.

The information processing apparatus of the other exemplary embodiment also produces similar effects to those of the first and second exemplary embodiment. In addition, according to the information processing apparatus of the other exemplary embodiments, screen information can be also updated for the area corresponding to screen information 21b on projection screen 22a of projector 22 in the screen display form shown in FIG. 3, for example.

Also in the other exemplary embodiment, processing related to the screen display control by controller 30 is provided by a program. The program may be provided to a user via a storage medium such as a CD-ROM and a DVD, or through a network typified by the Internet. For example, there is provided a program which is used in an information processing apparatus including first and second memories, a display that displays an image based on a video signal output from the first memory, and a video output terminal that outputs a video signal output from the second memory to an external device. This program causes a computer of the information processing apparatus to perform a processing operation for: writing screen information to be displayed on the display into the first memory, and periodically updating the written screen information, while at the same time periodically performing a data transfer from the first memory to the second memory by DMA control, and when executing a specific application, writing screen information related to the specific application into the first memory, thereafter, if a data transfer is performed by the DMA control, deleting the screen information related to the specific application from the first memory, updating the screen information other than the deleted screen information, causing the screen information that has been updated to be transferred from the first memory to the second memory, and after the transfer has been completed, rewriting the screen information related to the specific application into the first memory.

Each exemplary embodiment that has been described above is an example of the present invention, and the configuration and operation thereof may be changed without departing from the spirit of the present invention.

1. An information processing apparatus comprising:
first and second memories;
a DMA controller that periodically performs a data transfer from said first memory to said second memory;
a display that displays an image based on a video signal output from said first memory;
a video output terminal that outputs a video signal output from said second memory to an external device; and
a controller that, when executing a specific application, prohibits the screen information related to the specific application from being transferred by said DMA controller, and then writes the screen information into said first memory.

2. The information processing apparatus according to claim 1, further comprising:
a selector in which switching is performed between a first state in which a video signal output from said first memory is supplied to said display and video output terminal and a second state in which the video signal output from said first memory is supplied to said display, and a video signal output from said second memory is supplied to said video output terminal,
wherein said controller controls said selector to be in said second state during a period in which the specific application is executed, and said selector to be in said first state during other than said period.

3. The information processing apparatus according to claim 1, wherein
said DMA controller includes a table in which address information indicating a data range to which a transfer is to be performed is stored, and refers to the table to control the transfer of screen information from said first memory to said second memory,
said controller writes address information for a range in which the screen information is written into the table as a transfer-prohibited range before the screen information related to the specific application is written into said first memory, and
when address information indicating the transfer-prohibited range is written into the table, said DMA controller transfers screen information that is not included in a range identified by said address information.

4. An information processing apparatus comprising:
first and second memories;
a DMA controller that performs a data transfer from said first memory to said second memory;
a display that displays an image based on a video signal output from said first memory;
a video output terminal that outputs a video signal output from said second memory to an external device; and
a controller that writes screen information to be displayed on said display into said first memory, and periodically updates the written screen information, while at the same time controlling said DMA controller to periodically perform a data transfer, wherein
when executing a specific application, said controller writes the screen information related to the specific application into said first memory, thereafter, if causing said DMA controller to transfer data, deletes the screen information related to the specific application from said first memory, updates screen information other than the deleted screen information, causes the screen information that has been updated to be transferred from said first memory to said second memory, and after the transfer has been completed, rewrites the screen information related to the specific application into said first memory.

5. The information processing apparatus according to claim 1, wherein the specific application comprises a tool for a graphical user interface for remotely controlling the external device.

6. A screen display control method comprising:
periodically performing a data transfer from a first memory to a second memory by DMA control, displaying an image based on a video signal output from said first memory on a display, and supplying a video signal output from said second memory to a video output terminal to which an external device is connected, and
when executing a specific application, prohibiting the screen information related to the specific application from being transferred by the DMA control, and then writing the screen information into said first memory.

7. A screen display control method which is performed in an information processing apparatus including first and second memories, a display that displays an image based on a video signal output from said first memory, and a video output terminal that outputs a video signal output from said second memory to an external device, said screen display control method comprising:
writing screen information to be displayed on said display into said first memory, and periodically updating the written screen information, while at the same time periodically performing a data transfer from said first memory to said second memory by DMA control, and
when executing a specific application, writing screen information related to the specific application into said first memory, thereafter, if a data transfer is performed by the DMA control, deleting the screen information related to the specific application from said first memory, updating screen information other than the deleted screen information, causing the screen information that has been updated to be transferred from said first memory to said second memory, and after the transfer has been completed, rewriting the screen information related to the specific application into said first memory.

8. A recording medium recorded with a program causing a computer to execute processes of:
periodically transferring screen information stored in a first memory to a second memory by DMA control, while at the same time displaying an image based on a video signal output from said first memory on a display, and supplying a video signal output from said second memory to a video output terminal to which an external device is connected, and
when executing a specific application, prohibiting screen information related to the specific application from being transferred by the DMA control, and then writing the screen information into said first memory.

9. A recording medium recorded with a program which is used in an information processing apparatus including first and second memories, a display that displays an image based on a video signal output from said first memory, and a video output terminal that outputs a video signal output from said second memory to an external device, said program causing a computer of the information processing apparatus to execute processes of:
writing screen information to be displayed on said display into said first memory, and periodically updating the written screen information, while at the same time periodically performing a data transfer from said first memory to said second memory by DMA control, and
when executing a specific application, writing screen information related to the specific application into said first memory, thereafter, if a data transfer is performed by the DMA control, deleting the screen information related to the specific application from said first memory, updating screen information other than the deleted screen information, causing the screen information that has been updated to be transferred from said first memory to said second memory, and after the transfer has been completed, rewriting the screen information related to the specific application into said first memory.

10. The information processing apparatus according to claim 2, wherein
said DMA controller includes a table in which address information indicating a data range to which a transfer is to be performed is stored, and refers to the table to control the transfer of screen information from said first memory to said second memory,
said controller writes address information for a range in which the screen information is written into the table as a transfer-prohibited range before the screen information related to the specific application is written into said first memory, and
when address information indicating the transfer-prohibited range is written into the table, said DMA controller transfers screen information that is not included in a range identified by said address information.

11. The information processing apparatus according to claim 2, wherein the specific application comprises a tool for a graphical user interface for remotely controlling the external device.

12. The information processing apparatus according claim 3, wherein the specific application comprises a tool for a graphical user interface for remotely controlling the external device.

13. The information processing apparatus according to claim 3, wherein the specific application comprises a tool for a graphical user interface for remotely controlling the external device.

14. The information processing apparatus according to claim 4, wherein the specific application comprises a tool for a graphical user interface for remotely controlling the external device.
